(19) United States
(12) Patent Application Publication
(10) Pub. No.: US 2005/0174756 A1
(43) Pub. Date: Aug. 11, 2005

(54) Illuminating assemblies with mirrors

(76) Inventor: Paul Verburg, London (GB)

Correspondence Address: MICHAEL BEST & FRIEDRICH, LLP, 100 E WISCONSIN AVENUE, MILWAUKEE, WI, 53202, US

(21) Appl. No.: 10/503,146

(22) PCT Filed: Jan. 29, 2003
(86) PCT No.: PCT/GB03/00368

(30) Foreign Application Priority Data
Jan. 29, 2002 (GB) 0201999.0

(51) Int. Cl. F21V 33/00

(52) U.S. Cl. 362/140; 362/136; 362/156

(57) ABSTRACT

The present invention relates to a flat mirror assembly of approximate dimensions 100 mm length×50 mm with ×5-7 mm thickness. The assembly (10) comprises: a substantially planar mirror (12); illumination means (14) for emitting diffused light for illuminating a person spaced from the mirror along a line N normal thereto; a flat battery or batteries (16) for powering the illumination means; an electrical circuit (18) between the battery and the illumination means; and a frame (20) for supporting the mirror, illumination means, power source and electrical circuit. The present invention also relates to a bag (100) having an anterior (102) in which items can be carried and a closure (104) for closing the interior space portion, illumination means (106) for illuminating the interior, a power source (108) for the illumination means and switch means (110) which may be responsive to said flap being opened thereby to activate said illumination means.

The present invention relates to illuminating assemblies including a flat mirror assembly and a bag or case with interior illumination.

Mirror assemblies are known which comprise a planar reflection means and a light source for illuminating a subject spaced from the reflection means along a line normal thereto. With increased illumination the subject is more readily able to view their reflection especially in low ambient lighting conditions. One of the problems with known assemblies is that the emitted light is relatively intense, and because the subject is looking almost directly at the light source, pupillary contraction occurs, which reduces the ability of the subject to view their reflection. This phenomenon, which can be likened to viewing objects whilst looking towards the sun, is particularly acute when ambient light is low, because of the increased contrast with the intensity of light or glare from the light source.

There also exists the problem that prior assemblies do not provide an even distribution of light, without commensurately increased intensity of light or glare. It may be desirable to provide an even distribution, with reduced shadowing, to improve the quality of the subject's reflection. This may make it easier, for instance, for a subject to apply make-up properly. An even spread of light can also be more flattering to a subject.

The prior art devices also suffer from their size and bulkiness. This reduces their applicability as portable assemblies which can be conveniently carried. It would also be desirable to provide an assembly which can readily be incorporated into a ladies, or make-up, compact or other devices, gags or cases incorporating a mirror.

Traditionally, when a bag, or case, is opened, especially in low ambient lighting conditions, the contents of the bag are not well lit and are difficult to identify.

The present invention seeks to overcome or at least to mitigate the above mentioned problems.

Aspects of the present invention are defined in the accompanying claims.

According to a further aspect of the present invention, there is provided a flat mirror assembly comprising planar reflective means; illumination means for emitting light for illuminating a subject spaced from the reflective means along a line normal thereto; a power source for powering the illumination means; an electrical circuit between the power source and the illumination means; and a frame for supporting the reflection means, the illumination means, power source and electrical circuit; wherein the illumination means comprises at least one LED.

In order that the present invention may be well understood, various embodiments thereof which are given by way of example only, will now be described with reference to the accompanying drawings, in which:

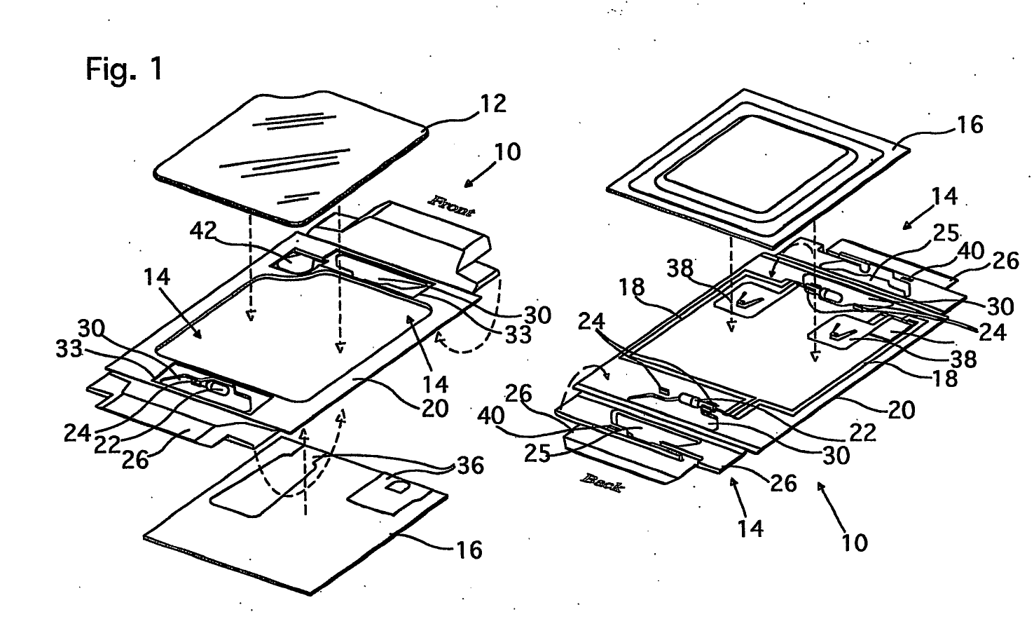

FIG. 1 is a partially exploded view, from the front and the back, of a portable flat mirror assembly,

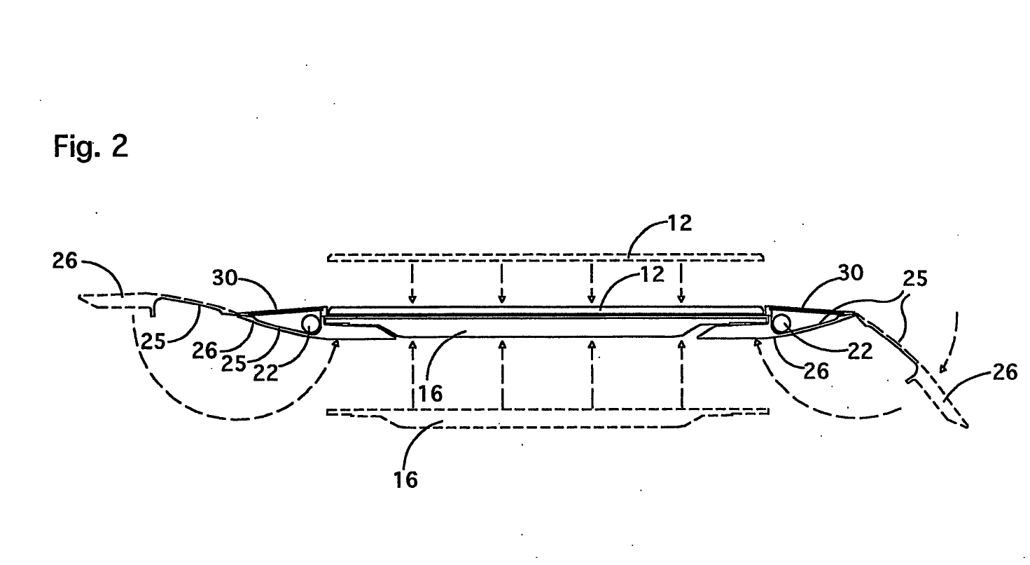

FIG. 2 is side view of the assembly of FIG. 1;

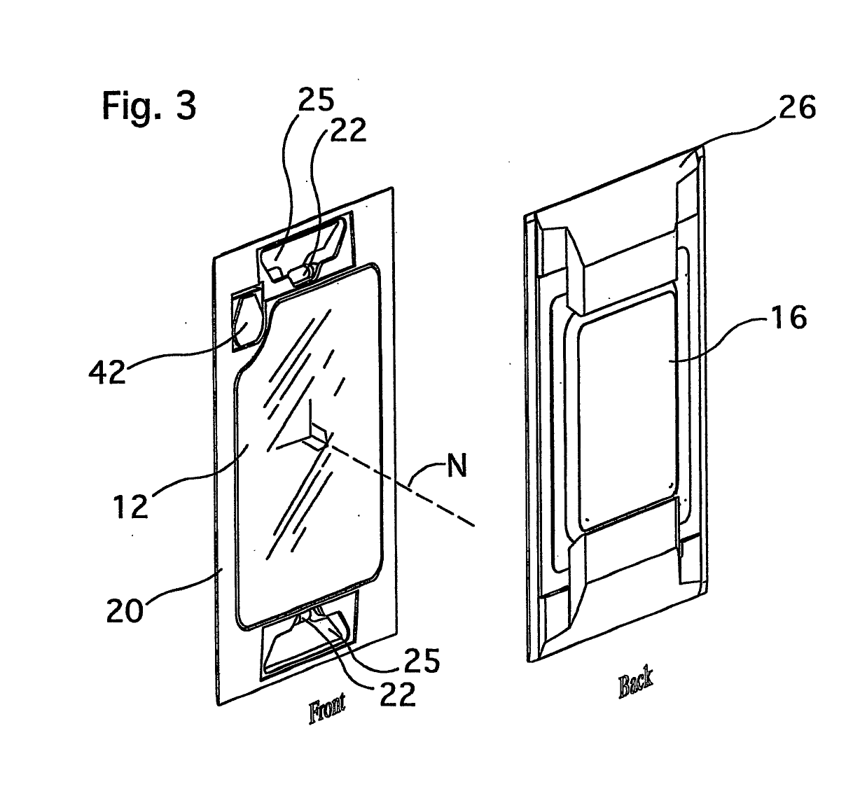

FIG. 3 shows the assembly of FIG. 1;

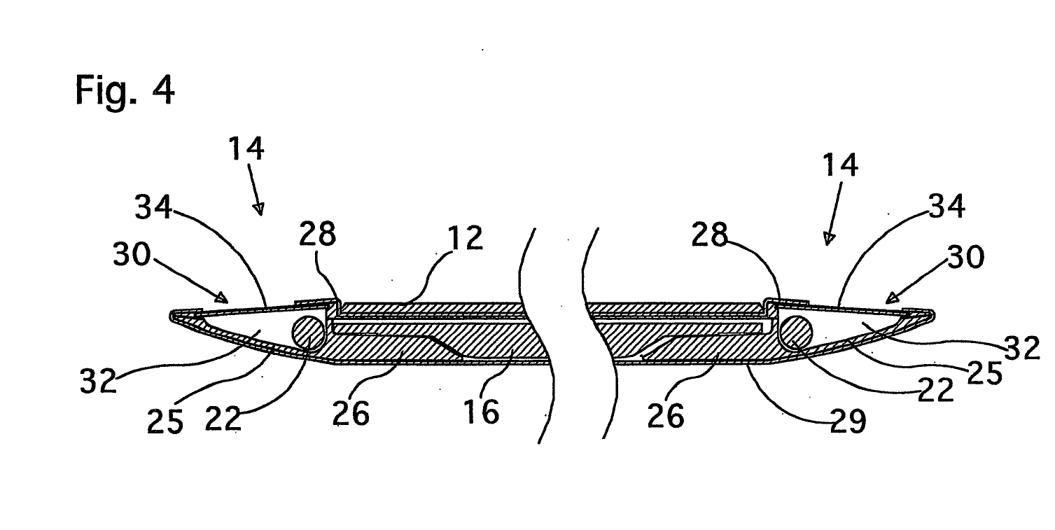

FIG. 4 is a cross-sectional view of the assembly of FIG. 1 in a finished state;

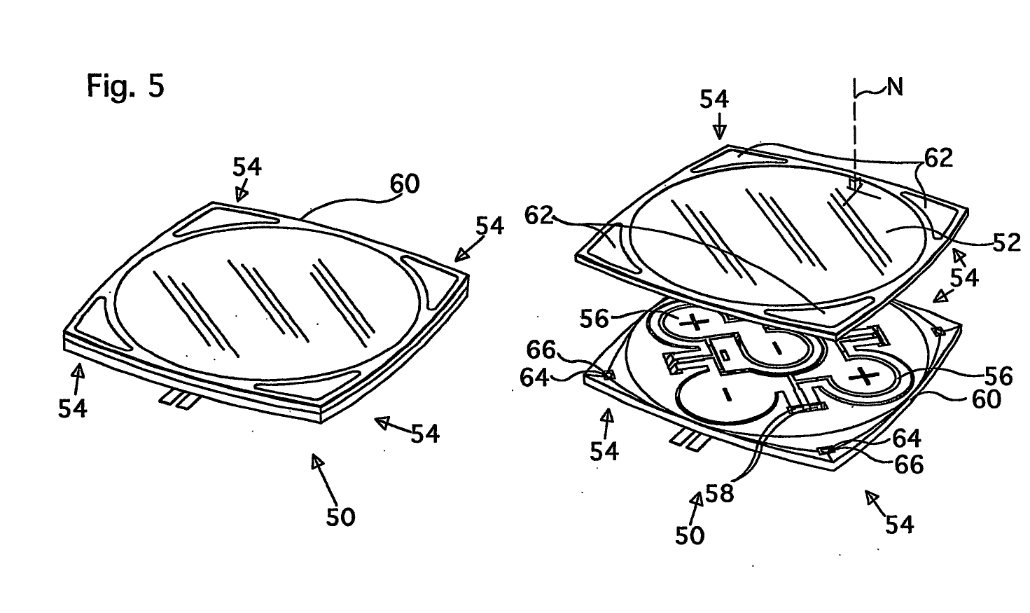

FIG. 5 is a partially exploded view of another portable flat mirror assembly specifically designed to be incorporated into a ladies compact;

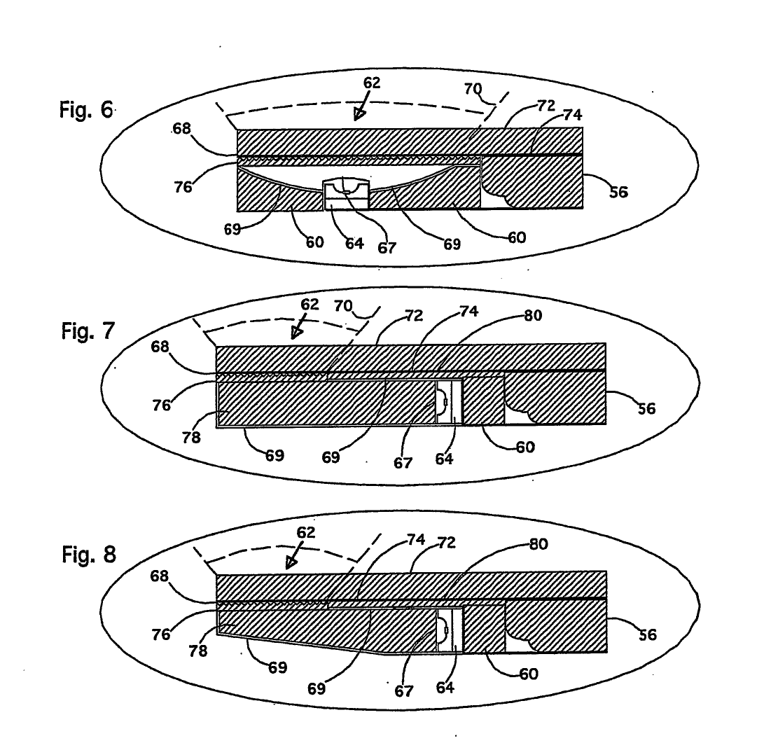

FIG. 6 is a cross-sectional view of the illumination means of the assembly of FIG. 5 in more detail;

FIGS. 7 and 8 are cross-sectional views of alternative illumination means;

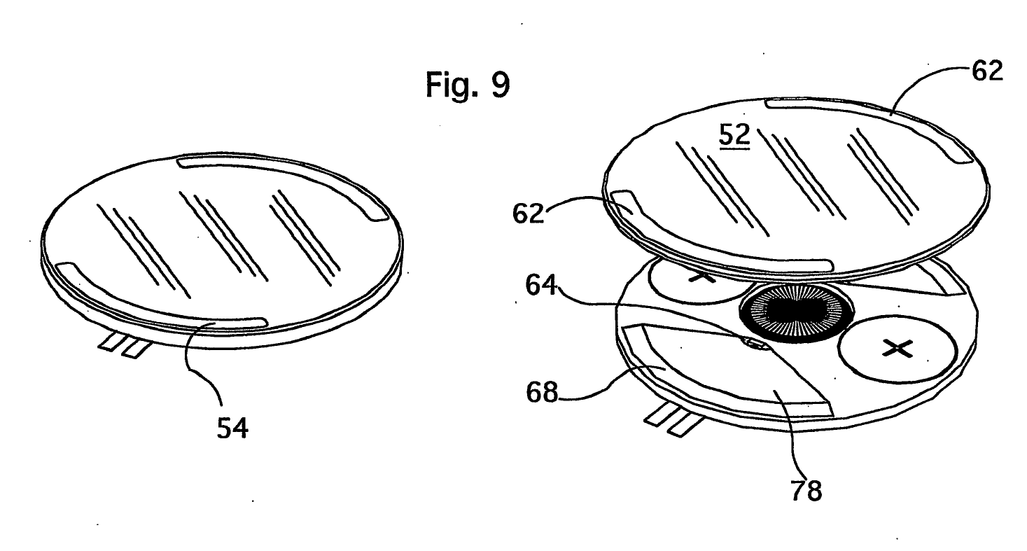

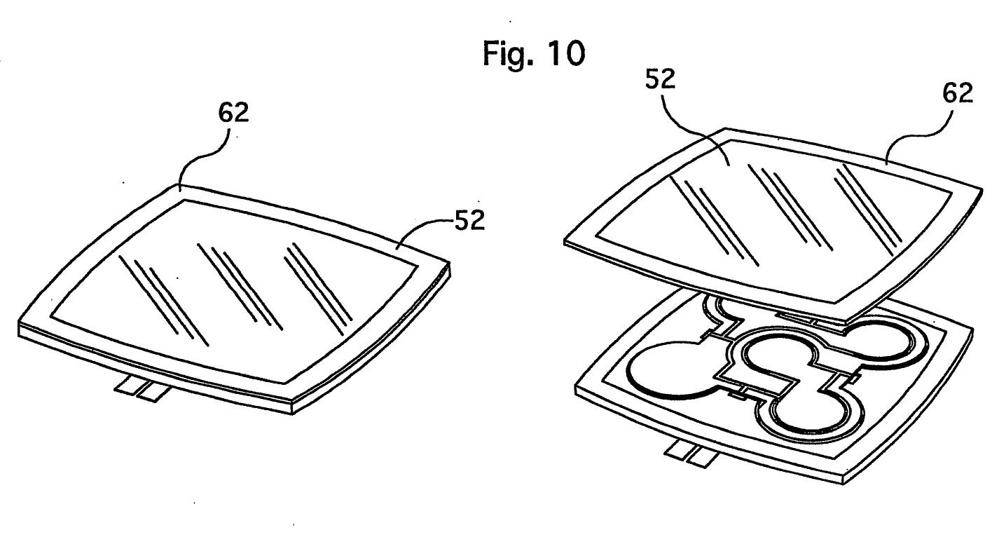

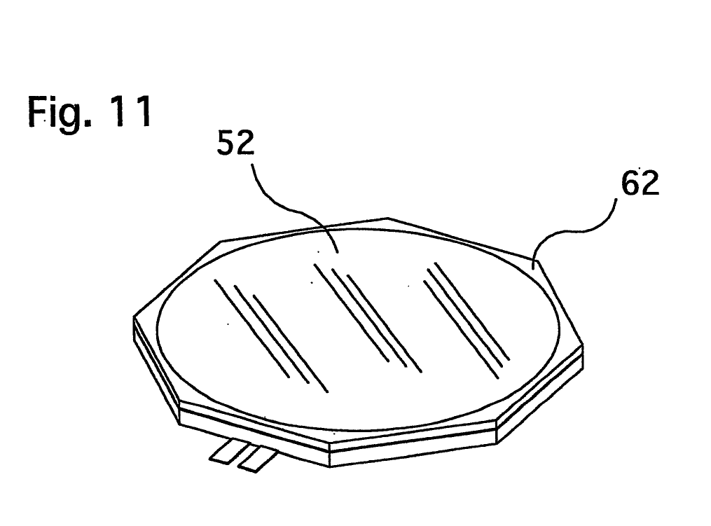

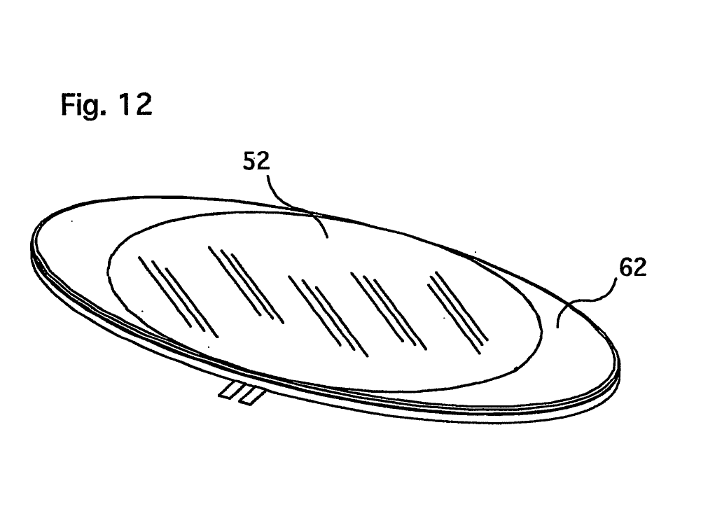

FIGS. 9 to 13 are perspective views of further assemblies;

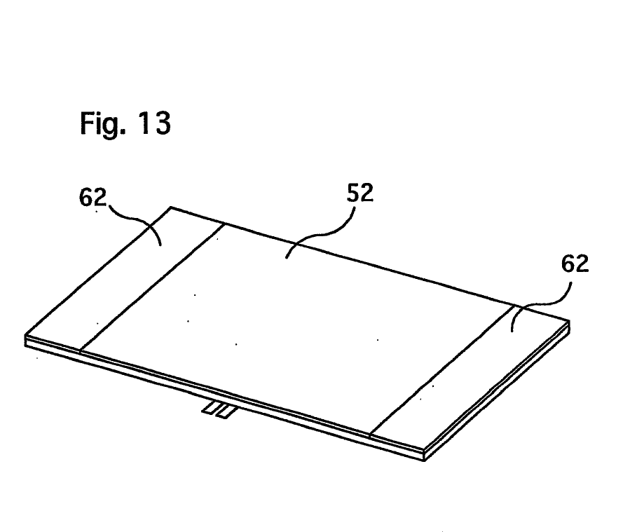

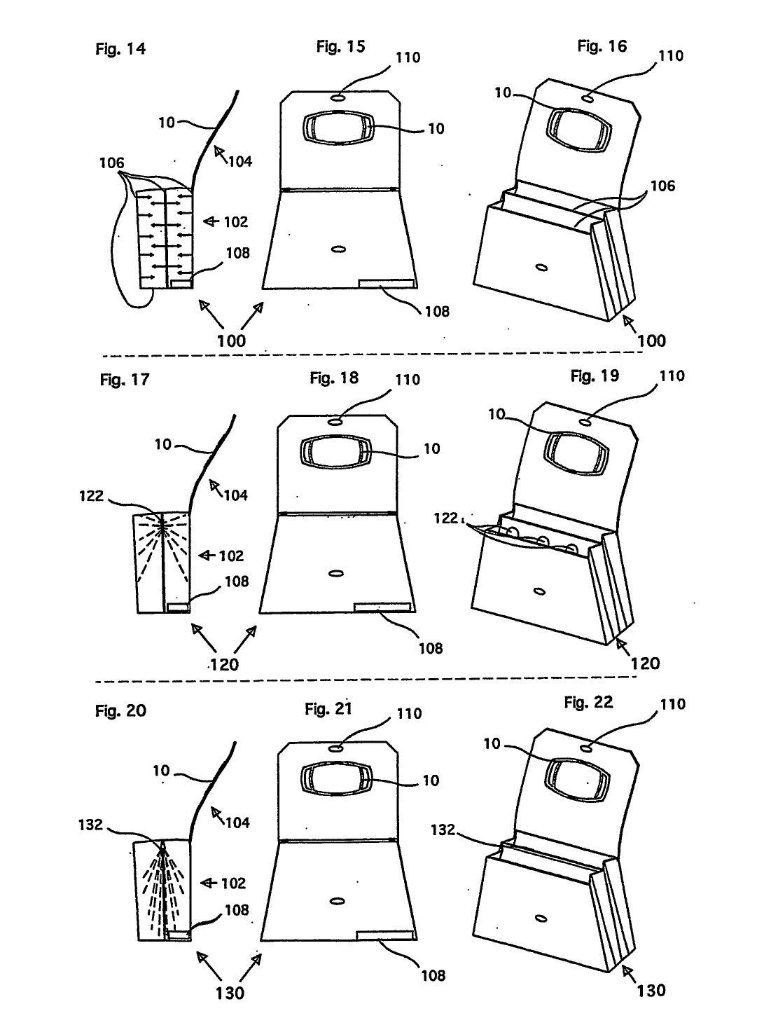

FIGS. 14 to 16 are cross-sectional, front and perspective views, respectively, of a bag with illuminated interior;

FIGS. 17 to 19 are cross-sectional, front and perspective views, respectively, of a further bag with illuminated interior; and

FIGS. 20 to 22 are cross-sectional, front and perspective views, respectively, of a still further bag with illuminated interior.

Referring to FIGS. 1 to 4, a portable flat mirror assembly is shown. By portable, what is meant is that the assembly can be conveniently carried and held, and has its own internal power source, such as a battery. The assembly is flat in the sense that its thickness is small relative to its width and length and may have dimensions, for example, of 100 mm length×50 mm width×5-10 mm thickness. The shape of the assembly is enabled by the choice and arrangement of the power source as well as the design of the frame and other components, meaning that a thickness of less than 7 mm can be achieved. In currently preferred embodiments the thickness is 5 mm.

The assembly is indicated generally at 10 and comprises: a substantially planar reflection means 12; illumination means 14 for emitting diffused light for illuminating a subject (not shown) spaced from the reflection means along a line N (see FIG. 3) normal thereto; a power source 16, which as shown is a flat battery, for powering the illumination means; an electrical circuit 18 between the power source and the illumination means; and a frame 20 for supporting the reflection means, illumination means, power source and electrical circuit.

The reflection means may be constituted by an integral plastic, glass or metal mirror or possibly a highly polished or painted surface of the frame 20. The reflection means can also be slightly concave to achieve magnification.

One or more illumination means 14 can be provided but as shown assembly 10 comprises two illumination means positioned to the side of the reflection means and power source 16 which is advantageous to provide even illumination of a subject. Positioning the illumination means in this way also enables a reduction in the thickness of the assembly i.e. the limiting factor in the present embodiment is the combined thickness of the reflection means and power source, and as battery technology improves further reduction in overall thickness can be achieved. The illumination means comprises a light source 22 which is preferably a miniature lamp or a Light Emitting Diode (LED). Recently, LED technology has improved to the extent that LEDs are now suitable for active as well as passive lighting applications. The light source is mounted to the frame 20 by any suitable means such as a catch 24 as shown. The light source is positioned so that it is screened from view either by portion 28 of a jacket (see FIG. 4 for more detail) or by part of the frame (in a modification of this embodiment), so that when a subject is viewing their reflection in the reflection means, light cannot travel directly from the light source to the subject. This arrangement reduces the glare from the illumination means 14 and therefore mitigates the problem of pupillary contraction or partial blindness, and thus improves the ability of the subject to view their reflection even in low ambient lighting conditions.

The illumination means 14 comprises a reflector 25, for guiding light to remote areas of the assembly, which is mounted to or integral with a pivotal portion 26 of the frame 20. As shown in FIG. 2, portion 26 is pivotal between the position shown in broken lines and the position shown in solid lines. This pivotal arrangement facilitates assembly since the power source can be snap-fitted in place (see further description below) and optionally allows easy removal of the power source for replacement or recharging. As shown in FIG. 4, a portion 28 of a jacket 29 screens direct light from travelling to a subject, so that the only light that reaches the subject is first reflected by reflector 25. The reflected light is emitted through aperture 30 in the illumination means, the aperture having a relatively larger area as compared with the light source thereby reducing the intensity or glare of the light whilst still achieving good illumination of a subject. Aperture 30 may additionally be provided with a diffusing layer (not shown) to further diffuse light emitted from the illumination means. Light emitted from the light source travels into cavity 32 (may be filled with a transparent medium) in which multiple reflections from reflector 25 take place prior to leaving through aperture 30. Advantageously, an enhancement layer 34 may be provided in aperture 30 for directing light towards a subject and a micro-replicated enhancement film is particularly suitable for this purpose. Such a film comprises a prismatic structure which allows light through only when it is travelling at a relatively acute angle to the normal and internally reflects light travelling at a greater angle thereto. This produces multiple internal reflections within cavity 32 allowing light to leave the illumination means only when it is travelling approximately towards a subject. The benefit of using an enhancement layer, is that, a relatively less powerful light source can be adopted, which prolongs the life of the power source, or alternatively, means that a smaller power source can be used, reducing the overall size of the assembly.

A recess 33 is provided in the frame 20 for receiving the enhancement layer, diffusion layer or colour filter layer, if present.

The light emitted from the illumination means may be passed through a colour filter to improve the hue of the light. For instance, when LEDs are used as the light source, the light is a harsh white blue colour which may be perceived as unflattering to the subject viewing their reflection whilst also producing more glare. A colour filter which prevents a portion of the blue spectrum from being emitted may improve the colour of the light and present a more aesthetically flattering reflection. For instance, a typical incandescent tungsten light bulb produces a pleasing yellow-white colour but is not efficient as a light source. The colour filter may take the form of a layer disposed across aperture 30 or a gel covering the light source 22.

The power source 16 is preferably a flat battery, such as a lithium battery, many examples of which are available. The battery has terminals 36 shown in FIG. 1 which when mounted in the assembly make electrical contact with contacts 38. The battery is mounted in position as shown by the arrows in the back view of the assembly in FIG. 1, and fastened in position by rotation of portions 26 as shown in FIG. 2 so that openings 40 of portions 26 mate with catches 24. This arrangement enables rapid assembly. Contacts 38 are connected by electrical circuit 18 to the light sources 22. The electrical circuit can be a flexible printed circuit (FPC), such as a back sided flex circuit or a single sided flex circuit, or alternatively the circuit can be etched into the surface of the frame. Another possibility would be to provide insulated wires although this is not currently preferred. Switch 42 is operable to close the electrical circuit between the battery 16 and the light source 22. The switch can be a push, slide, toggle or any other appropriate switch.

Frame 20 can be made from any suitable material, such as injection moulded plastic (transparent or coloured) or metal stamped from a blank. The frame need not be one-piece but instead may be formed from a front and back piece for instance. The surface of the fame can be fashioned in any desirable way.

Although it is not necessary to provide a jacket 29, its provision neatly encloses the workings of the assembly. The jacket may be made of any suitable material, such as rubber, plastic, metal, card or paper, and can be embossed or coloured to present advertising material.

In use, a subject positions the assembly so that their reflection can be viewed in the reflection means 12. Operation of the switch 42 closes the electrical circuit which activates the light source 22. Diffused light is emitted from the illumination means illuminating the subject so that their reflection can be viewed more clearly.

Referring to FIGS. 5 to 12, further portable flat mirror assemblies are shown, which are particularly adapted for use in a typically sized ladies compact. Unless otherwise described, the components of these embodiments are similar to those of the previous embodiment. In order to achieve an assembly which fits into such a compact, the assembly has to be small and the arrangements shown in the drawings enable a miniaturised design. These assemblies are also suitable for, without limitation, hand mirrors, handbag mirrors, handbag flap mirrors, magnifying mirrors, mirror cases, contact lens cases, make-up kit cases, and shaving mirrors.

FIG. 5 shows a perspective view and a partially exploded view of a further assembly 100. The assembly comprises a planar reflection means 50; illumination means 54 for emitting diffused light for illuminating a subject spaced from the reflection means along a line N normal thereto; a power source 56 for powering the illumination means; an electrical circuit 58 between the power source and the illumination means; and a frame for supporting the reflection means, illumination means, power source and electrical circuit.

The reflection means 52 may be constituted as described above with reference to FIGS. 1 to 4. As shown, the reflection means is formed by a transparent layer 72 and an amalgam coating layer 74 (see FIGS. 6 to 8), providing a reflective surface. The coating layer does not cover the entire back surface of the transparent layer leaving one or more, four as shown, transparent windows 62 through which light can pass.

Four illumination means 14 are provided in assembly 50 around the generally circular reflection means. This arrangement is advantageous to provide even illumination of a subject. Each illumination means comprises a light source 64 which is preferably a Light Emitting Diode (LED) as shown. The light source is mounted in a recess 66 in the frame 60 and may be glued or moulded into place, as required. Further description of the illumination means will be made with reference to FIGS. 6 to 8 which show three different arrangements.

Unlike the previous embodiment shown in FIGS. 1 to 4, the light source, LED, 64 is positioned to allow light to travel directly through the transparent window to the subject In this case, a diffuser layer 68 can be provided to diffuse the light travelling to the subject, reduce glare and improve the ability of the subject to view their reflection. Alternatively, the transparent windows 62 can be etched to diffuse the light. A colour filter layer (not shown) can also be provided or alternatively a condom type or gel type layer 67 can be fitted over the LED to render a complimentary light quality. The frame 60 is concavely shaped and provided with a reflective finish 69, such as an amalgam or reflective matt white spray-paint, to reflect light from the LED towards the subject as shown by the cone of illumination 70 in broken lines. The coating layer 74 is shown deposited on the back surface of the transparent layer 72. An enhancement layer 76 can be provided for directing light towards a subject.

In the illumination means shown in FIG. 7, the light source is screened from the subject by laterally extending the coating layer 74. The illumination means comprises a light guide 78 made from acrylic or glass, for example. Light emitted from the LED cannot travel directly to the subject but is, instead, is guided to remote areas of the assembly by being reflected internally within the light guide until it is emitted through transparent window 62. An enhancement layer 76 is preferably adopted to prevent light from leaving the light guide until it is travelling generally towards the subject. The advantage of incorporating the light guide arrangement as shown in FIG. 7 is that light can be directed and emitted from the illumination means in any of a number of varying patterns, as can be seen from the assemblies shown in FIGS. 9 to 12. Such patterns may be chosen to enable even illumination of the subject, which reduces shadowing and provides more complimentary lighting. It also means that the assemblies are very adaptable and can be arranged in compacts, or other devices, of any of a number of different shapes.

The assembly shown in FIG. 8 differs from that shown in FIG. 7 in that the light guide is wedge-shaped having a chamfered outer edge. This shape is adopted to improve the angle at which light is reflected towards the transparent window 62.

In FIGS. 7 and 8 an adhesive 80 may be used to adhere the illumination means 54 with the reflection means 52.

FIGS. 9 to 13 show various different assemblies adopting differing arrangements of the reflection means 52 and the transparent windows 62. The arrangement of the LEDs and light guides are shown in FIG. 9 but omitted in FIGS. 10 to 13. However, from an understanding of the present description, it will be apparent how the LEDs and light guides can be arranged to provide the assemblies shown in FIGS. 10 to 13. In FIG. 9, two LEDs 64 are provided for emitting light into respective light guides 78. The light produced from each LED is distributed over a relatively large area i.e. the area of the transparent windows 62, and this reduces glare whilst providing an even illumination of the subject. The provision of only two LEDS means that less power is required and therefore fewer or thinner batteries are needed, contributing to reduced overall size of the assembly.

The batteries adopted in the assemblies shown in FIGS. 5 to 13 are coin batteries which are typically used in small electrical devices such as calculators and watches. These type of batteries are small, thin and relatively inexpensive. As shown in the Figures, the batteries can be arranged in the same plane in the frame to reduce overall thickness. Five such batteries are used in the embodiment shown in FIG. 5.

Advantageously, when any of the assemblies are fitted in a compact, a switch is provided for automatically activating the illumination means when the lid of the compact is opened.

In summary of the above embodiments, the brightness of the image viewed in the reflection should be as close as possible to the brightness of the illumination source, which is illuminating the face. As one aim of the devices is to illuminate the reflection in low light conditions, the devices should be effective in low ambient light conditions.

The smaller the illuminating mirror device the more critical the contrast between the illumination source and the brightness of the subjects reflection. If the light source exceeds a certain level the contrast will be too great and the image will appear dim in comparison and this will cause discomfort to the operator. An extreme example is the bright light interrogation technique, being the effect experienced when trying to view the face of a person standing beside a spotlight directed at your face when the rest of the room is dark.

The size of the image viewed on a reflective surface (The reflective surface being a flat mirror or non magnifying mirror) is under half that of the subject of the reflection. The most appropriate position for the light source is from the perimeter of the reflective surface to evenly illuminate the subject so the smaller the device the more critical the balance between brightness of the illumination source and the brightness of the reflected subject.

To overcome this problem the solution is to maintain the maximum amount of illumination while reducing the brightness. This is achieved in the embodiments by increasing the light emitting area of the illumination source while maintaining the same level of illumination consequently reducing the brightness, thereby reducing the contrast between the image reflected and the illumination source.

This is achieved in one way by using micro replicated film eg 3M®'s Optical Lighting Film (film with very precise prisms on one side and a very smooth finish on the other) which only transmits light emitted at the correct angle (that light that is directed perpendicular to the surface of the reflection) all other light is bounced back into the reflective surface of the cavity and re-emitted when the correct angle to transmit is achieved. In so doing the light is effectively spread evenly over the illumination window, thereby maintaining the same level of illumination whilst reducing the overall brightness of the illumination source. It is also the efficient use of available lumens and power supply as all light produced is directed onto the subject.

Prior art devices have tried to overcome the problem solved by the embodiments by positioning the light source remotely from the illumination window but are inefficient because they direct a very small amount of the available light onto the actual subject. Others use a number of illumination sources, which limit the size of the device and still do not efficiently direct the available light onto the subject.

FIGS. 14 to 22 show a handbag having interior illumination and which can be incorporated with the any of the assemblies of the previous embodiments. Alternatively, any other bag or case may be adopted instead of the handbag such as a shoulder bag, a brief case, a carry-all, a suitcase, a rucksack, a clutch bag, or a belt bag.

FIGS. 14 to 16 show a bag 100 having an interior space portion 102 in which items can be carried and closure means, or portion, 104 for closing the interior space portion, illumination means 106 for illuminating said interior space portion, a power source 108 for the illumination means and switch means 110 which may be responsive to said closure portion being opened thereby to activate said illumination means. Optionally, an assembly 10 can be provided in the closure portion.

The illumination means 106 comprises electro-luminescent panels, such as those made by Elastolite®, provided in the lining of the bag or alternatively electro-luminescent wire incorporated in the trim. The power source can be a rechargeable or replaceable battery.

The switch 110 is preferably incorporated in a catch of the bag so that when the bag is opened the switch activates the illumination means 106. Alternatively, the switch can be arranged between the closure portion 104 and the interior space portion 102 and can sense relative movement therebetween so that when the closure portion is opened the illumination means is activated.

Preferably, the bag comprises a timer which can deactivate the illumination means a predetermined amount of time after the bag is opened. This saves power should the bag be left open for long periods.

The bag 122 of FIGS. 17 to 19 is similar to the bag 100 of FIGS. 14 to 16 and only the differences therebetween will be described. In this regard, the illumination means 122 comprises LEDs and preferably panels of LED illuminating acrylic or glass guides.

The bag 130 of FIGS. 20 to 22 is similar to the bag 100 of FIGS. 14 to 16 and only the differences therebetween will be described. In this regard, the illumination means 132 comprises miniature filament light bulbs or a plurality of single LEDs directed into the interior space portion 102.

Although the embodiments shown in FIGS. 1 to 13 relate to portable flat mirror assemblies, it will be appreciated that the present invention is applicable to non-portable assemblies, such as assemblies incorporated in the sun-visor of an automobile.

1. A flat mirror assembly comprising a planar mirror or reflection surface; an illumination assembly for emitting diffused light for illuminating a subject spaced from the mirror or reflection surface along a line normal thereto; a power source for powering the illumination assembly; an electrical circuit between the power source and the illumination assembly; and a frame for supporting the mirror or reflection surface, the illumination assembly, power source and electrical circuit.

2. An assembly as claimed in claim 1, wherein the surface of the illumination assembly from which light is emitted is substantially larger than the surface of a light source to reduce glare of the light illuminating the subject.

3. An assembly as claimed in claim 1, wherein the illumination assembly comprises a light source and a light diffusing layer through which light is to pass to illuminate such a subject.

4. An assembly as claimed in claim 1, wherein the illumination assembly comprises a light source, and the assembly further comprises a screen for preventing light from the light source travelling directly to such a subject and a light guide for guiding and diffusing light from the light source for illuminating such a subject.

5. An assembly as claimed in claim 4, wherein the light guide is for guiding lighting from the light source to remote areas of the assembly.

6. An assembly as claimed in claim 1, wherein the illumination assembly comprises an enhancement layer through which light is to pass for illuminating such a subject, the enhancement layer increasing the proportion of light from the illumination assembly travelling at an acute angle to said normal line thereby enhancing illumination of such a subject.

7. An assembly as claimed in claim 1, wherein the illumination assembly comprises a color filter for improving the color of the light emitted from a slight source for illuminating such a subject.

8. An assembly as claimed in claim 1, wherein the power source is one or more flat lithium batteries.

9. An assembly as claimed in claim 1, wherein the power source comprises one or more coin batteries.

10. An assembly as claimed in claim 1, wherein the power source is snap-fit into position on the frame.

11. An assembly as claimed in claim 1, wherein the illumination assembly comprises at least one LED.

12. An assembly as claimed in claim 1, wherein the illumination assembly emits light from substantially the same plane as that of the planar mirror or reflection surface.

13. An assembly as claimed in claim 1, wherein the assembly is portable.

14. An assembly as claimed in claim 1, wherein the assembly has a thickness of less than 10 mm.

15. An assembly as claimed in claim 1, wherein the illumination assembly includes light sources positioned to sides of the power source.

16. (canceled)

17. (canceled)

18. (canceled)

19. A case having an interior space portion in which items can be carried and a closure for closing the interior space portion, a light source for illuminating said interior space portion, a power source for the light source and a switch to activate said light source.

20. A case as claimed in claim 19, wherein the switch is responsive to said closure being opened thereby to activate said light source.

21. A case as claimed in claim 19, further comprising a timer for deactivating the light source a predetermined time after the closure is opened.

22. A case as claimed in claim 19, wherein said light source comprises an electroluminescent light source.

23. A case as claimed in claim 22, wherein the electroluminescent light source is a film incorporated into the structure of the case.

24. A case as claimed in claim 23, wherein the electroluminescent light source is a wire incorporated into the structure of the case.

25. A case as claimed in any one of claim 19, wherein the light source comprises at least one LED.
